(19) United States
(12) Patent Application Publication
(10) Pub. No.: US 2018/0083733 A1
(43) Pub. Date: Mar. 22, 2018

(54) Receiving Device and Methods Thereof

(71) Applicant: Huawei Technologies Co., Ltd., Shenzhen (CN)

(72) Inventors: Jianjun Chen, Lund (SE); Fredrik Rusek, Lund (SE); Junshi Chen, Shenzhen (CN); Peter Almers, Shenzhen (CN); Baicheng Xu, Shenzhen (CN)

(21) Appl. No.: 15/822,847

(22) Filed: Nov. 27, 2017

Related U.S. Application Data
(63) Continuation of application No. PCT/EP2015/065145, filed on Jul. 2, 2015.

(51) Int. Cl. H04L 1/00; H04L 25/03

(52) U.S. Cl. CPC H04L 1/0048; H04L 25/03006

(57) ABSTRACT

A receiving device including a receiver configured to receive a communication signal (CS) in a current time frame, and a processor configured to determine a set of candidate Control Channels (CCHs), determine a decoding order for the candidate CCHs in the set, decode at least one candidate CCH in the set according to the decoding order, compute a possible Radio Network Temporary Identifier (RNTI) for the decoded candidate CCH, compute a metric value (MV) for the decoded candidate CCH, the MV provides an indication when the decoded candidate CCH might be an actual CCH, determine when the decoded candidate CCH is an actual CCH based on the computed possible RNTI and the MV, derive control information (CI) from the decoded candidate CCH when the decoded candidate CCH is determined as an actual CCH, and cancel or suppress interference in the CS based on the derived CI.

### CROSS-REFERENCE TO RELATED APPLICATION

This application is a continuation of International Patent Application No. PCT/EP2015/065145 filed on Jul. 2, 2015, which is hereby incorporated by reference in its entirety.

### TECHNICAL FIELD

The present disclosure relates to a receiving device. Furthermore, the present disclosure also relates to corresponding methods, a computer program, and a computer program product.

### BACKGROUND

Third Generation Partnership Project (3GPP) proposes a frequency reuse factor of 1 in Long Term Evolution (LTE) systems. Therefore, interference will generally be high in such LTE systems. For the downlink, a User Equipment (UE) will suffer from interference signal from neighbouring e-NodeB(s) (eNBs). The downlink interference will degrade the receiver performance of the UE.

One approach to deal with the LTE downlink interference is called Interference Rejective Combining (IRC). By measuring/estimating the statistics of the interference signals, the impact of the interference can significantly be mitigated with the IRC method.

Another approach to deal with the LTE downlink interference is the well-known Interference Cancellation (IC) method.

However, in LTE downlink, cancelling the interfering Physical Downlink Shared Channel (PDSCH) data from neighbouring cells is rather difficult, since usually the information or parameters of interfering signals are unknown. Such information may e.g. be transmission mode, transmission rank, precoding matrix, power level, modulation scheme, resource allocation, etc. In order to enable efficient IC, the above parameters or information of the interfering signals should be obtained, either by blind estimation or by other suitable approaches.

In order to obtain the signal parameters of the interfering PDSCH channel, there are several approaches according to conventional solutions.

One approach let the eNB inform the UE about the interfering signal parameters, i.e. network assisted approach. However, this approach puts too much overhead to network signalling and needs standard specification changes.

Another approach is to blindly detect the parameters of interfering signals from the received signal with interference. The advantage of this kind of solution is that this approach does not need standard specification changes and no extra control signalling overhead. However, the drawback is that too many parameters need to be detected and the detection ratio for some parameters is not satisfactory.

Yet another approach tries to decode the Physical Downlink Control Channel (PDCCH) channel corresponding to the interfering PDSCH, and then directly fetch the parameters of the interfering signals. The parameter blind detection performance degrades even further when there are multiple interfering PDSCH signals overlapped. Moreover, in a typical scenario when the interfering signals are a few decibels (dB) weaker than the designated wanted signal but still significantly above the background noise level, a good interference cancelation is able to provide significant throughput gain. However, since the interfering signal is weaker than the designated signal, detecting the parameters of the interfering signals becomes really difficult. Therefore the interference cancelation performance is in general not satisfactory with such blindly parameter detection approach.

### SUMMARY

An objective of embodiments of the present disclosure is to provide a solution which mitigates or solves the drawbacks and problems of conventional solutions. A further objective of the present disclosure is to provide a concept which enables an improved interference cancelation.

An “or” in this description and the corresponding claims is to be understood as a mathematical OR which covers “and” and “or”, and is not to be understood as an exclusive OR (XOR).

The above objectives are solved by the subject matter of the independent claims. Further advantageous implementation forms of the present disclosure can be found in the dependent claims.

According to a first aspect of the disclosure, the above mentioned and other objectives are achieved with a receiving device for a wireless communication system, the receiving device comprising a receiver configured to receive a communication signal (CS) in a current time frame, a processor configured to determine a set of candidate Control Channels (CCHs), wherein each candidate CCH in the set is addressed for another receiving device and associated with a Data Channel (DCH), of the CS determine a decoding order for the candidate CCHs in the set, decode at least one candidate CCH in the set according to the decoding order, compute a possible Radio Network Temporary Identifier (RNTI), for the decoded candidate CCH, compute a metric value (MV) for the decoded candidate CCH, the MV providing an indication if the decoded candidate CCH might be an actual CCH, determine if the decoded candidate CCH is an actual CCH based on the computed possible RNTI and the MV, derive control information (CI) from the decoded candidate CCH if the decoded candidate CCH is determined as an actual CCH, cancel interference or suppress interference in the CS based on the derived CI.

A number of advantages are provided by the receiving device according to the first aspect by which CI for interfering signals are obtained. One such advantage is that the receiving device can derive the CI precisely (more accurate, lower error rate, etc.) using the computed possible RNTI and the MV and use the derived CI to cancel or suppress interference efficiently, e.g. interference from neighbouring cells. Also the computing complexity can be reduced by determining the decoding order for the candidate CCHs in the set.

In a first possible implementation form of the receiving device according to the first aspect, the processor is configured to determine the decoding order based on the energy levels of the candidate CCHs in the set.

An advantage with the first possible implementation form is that the ordering is easy to implement and reliable because the strongest CCH is detected first and has higher possibility to be detected correctly since the strongest CCH is less interfered than other CCHs. Therefore, faster detection of the actual CCH is possible.

In a second possible implementation form of the receiving device according to first possible implementation form of the receiving device according to the first aspect or to the first aspect as such, the processor is further configured to check the validity of the derived CI, and discard the decoded candidate CCH from the set if the derived CI is invalid.

An advantage with the second possible implementation form is that by discarding candidate CCHs for which the CI is invalid the search space is reduced.

In a third possible implementation form of the receiving device according to second possible implementation form of the first aspect, the processor is further configured to discard other candidate CCHs from the set if the other candidate CCHs have been transmitted in the same Control Channel Elements (CCEs), as the decoded candidate CCH and the derived CI is valid.

The third possible implementation is based on the finding that some of the CCHs are mutually exclusive, such that if one exists then the others will not or cannot exist. By discarding other CCHs transmitted in the same CCE as the decoded candidate CCH, the detection problem is simplified and more accurate as less candidate CCHs need to be decoded.

In a fourth possible implementation form of the receiving device according to second or third possible implementation forms of the first aspect, the processor is further configured to check the validity of the derived CI based on the computed possible RNTI, the subframe number for the decoded candidate CCH, and CCE constraints for the decoded candidate CCH.

An advantage with the fourth possible implementation form is that the computed possible RNTI, subframe number of the decoded candidate CCH, and CCE constraints are associated with the candidate CCH and therefore the validity check of the derived CI is easy and efficient to implement.

In a fifth possible implementation form of the receiving device according to any of the preceding possible implementation forms of the receiving device according to the first aspect or to the first aspect as such, the processor is further configured to detect at least one current possible RNTIs for the decoded candidate CCH in the current time frame, compute an MV for the detected current possible RNTI, compute statistics for MVs associated with previously detected possible RNTIs for the decoded candidate CCH, determine if the decoded candidate CCH is an actual CCH further based on the computed statistics and the computed MV for the detected current possible RNTI.

An advantage with the fifth possible implementation form is that the statistic for metrics of previous detected possible RNTI can be used to verify the current metric and make the present detection of the RNTI more reliable.

In a sixth possible implementation form of the receiving device according to the fifth possible implementation form of the receiving device according to the first aspect, the computed MV for the detected current possible RNTI and the computed statistics are computed based one or more parameters in the group comprising type of RNTI, point in time of detection of the RNTI, and number of detections for the same RNTI.

An advantage with the sixth possible implementation form is that the computed statistics are based on the characteristics of the RNTI as mentioned above, therefore making the MV more reliable in determining whether the candidate CCH is an actual CCH.

In a seventh possible implementation form of the receiving device according to the fifth or sixth possible implementation forms of the receiving device according to the first aspect, Random Access RNTIs (RA-RNTIs), Paging RNTIs (P-RNTIs), and System Information RNTIs (SI-RNTIs), are special types of RNTIs (therefore indicating high probability that the decoded candidate CCH is an actual CCH), and wherein the processor is further configured to set the computed MV for the detected current possible RNTI, which is from the special types, higher than an MV for a detected current possible RNTI which is not from the special types.

An advantage with the seventh possible implementation form is that because different types of RNTIs have different possibility of occurrence it is advantageous to give different types of RNTIs different MVs such that they have different priority or possibility to be detected.

In an eighth possible implementation form of the receiving device according to the second to the seventh possible implementation forms of the receiving device according to the first aspect or to the first aspect as such, the receiving device is served by at least one serving cell, and the decoded candidate CCH is addressed for another receiving device associated with a non-serving cell.

An advantage with the eighth possible implementation form is that by detecting the CCH of another receiving device associated with a non-serving cell, cancelling the detected DCH from the received CS and improve the DCH detection possibility of the serving cell is possible.

In a ninth possible implementation form of the receiving device according to the second to the seventh possible implementation forms of the receiving device according to the first aspect or to the first aspect as such, the receiving device is served by at least one serving cell, and the decoded candidate CCH is addressed for another receiving device associated with the serving cell, and wherein the processor is further configured to store the CI in connection with mobility handling for the receiving device.

An advantage with the ninth possible implementation form is that the CI in connection with mobility or connection handling can be used after the receiving device is handed over to another cell such that good knowledge of the active RNTIs of the current interfering cell (which is the serving cell before the handover) is immediately at hand. This will improve interfering CCH detection performance after handover.

In a tenth possible implementation form of the receiving device according to any of the preceding possible implementation forms of the receiving device according to the first aspect or to the first aspect as such, the processor is further configured to compute the MV based on one or more information in the group comprising path metric of a decoder of the receiving device, Log Likelihood Ratio (LLR), statistics of the decoder, amount of change of LLRs of the decoder, raw Bit Error Rate (BER), estimate of the decoder, estimated Signal to Noise Ratio (SNR), or Signal to Noise and Interference Ratio (SNIR), for the candidate CCH, and effective coding rate for the candidate CCH.

An advantage with the tenth possible implementation form is that the mentioned information can be used to compute the MV in order to improve the performance and reliability of the MV calculation.

In an eleventh possible implementation form of the receiving device according to any of the preceding possible implementation forms of the receiving device according to the first aspect or to the first aspect as such, the CCH is a PDCCH, the DCH is a PDSCH, and the CI is Downlink Control Information (DCI).

An advantage with the eleventh possible implementation form is that the present solution can easily be implemented in LTE systems and can improve the neighbouring cell IC performance.

In a twelfth possible implementation form of the receiving device according to any of the preceding possible implementation forms of the receiving device according to the first aspect or to the first aspect as such, the processor is configured to determine the decoding order based on CCE aggregation levels (i.e. how many CCEs a candidate CCH occupies) of the candidate CCHs in the set. As an example candidate CCHs with higher aggregation level get a higher decoding priority (are earlier decoded) than candidate CCHs with lower aggregation level.

An advantage of this implementation form is that further candidate CCHs occupying the same (or only a part of the CCEs of the currently decoded candidate CCH) can be discarded when the currently decoded candidate CCH occupying the same CCEs is detected successfully.

According to a second aspect of the disclosure, the above mentioned and other objectives are achieved with a method for a wireless communication system, the method comprising receiving a CS in a current time frame, determining a set of candidate CCHs, wherein each candidate CCH in the set is addressed for another receiving device and associated with a DCH, of the CS, determining a decoding order for the candidate CCHs in the set, decoding at least one candidate CCH in the set according to the decoding order, computing a possible RNTI, for the decoded candidate CCH, computing an MV for the decoded candidate CCH, the MV providing an indication if the decoded candidate CCH might be an actual CCH, determining if the decoded candidate CCH is an actual CCH based on the computed possible RNTI and the MV, deriving CI from the decoded candidate CCH if the decoded candidate CCH is determined as an actual CCH, cancelling interference or suppress interference in the CS based on the derived CI.

In a first possible implementation form of the method according to a second aspect, the decoding order is based on the energy levels of the candidate CCHs in the set.

In a second possible implementation form of the method according to first possible implementation form of the method according to the second aspect or to the second aspect as such, the processor is further configured to check the validity of the derived CI, and discard the decoded candidate CCH from the set if the derived CI is invalid.

In a third possible implementation form of the method according to second possible implementation form of the method according to the second aspect, the processor is further configured to discard other candidate CCHs from the set if the other candidate CCHs have been transmitted in the same CCEs, as the decoded candidate CCH and the derived CI is valid.

In a fourth possible implementation form of the method according to the second or third possible implementation forms of the method according to the second aspect, the processor is further configured to check the validity of the derived CI based on the computed possible RNTI, the subframe number for the decoded candidate CCH, and CCE constraints for the decoded candidate CCH.

In a fifth possible implementation form of the method according to any of the preceding possible implementation forms of the method according to the second aspect or to the second aspect as such, the processor is further configured to detect at least one current possible RNTIs for the decoded candidate CCH in the current time frame, compute an MV for the detected current possible RNTI, compute statistics for MVs associated with previously detected possible RNTIs for the decoded candidate CCH, determine if the decoded candidate CCH is an actual CCH further based on the computed statistics and the computed MV for the detected current possible RNTI.

In a sixth possible implementation form of the method according to the fifth possible implementation form of the method according to the second aspect, the computed MV for the detected current possible RNTI and the computed statistics are computed based one or more parameters in the group comprising type of RNTI, point in time of detection of the RNTI, and number of detections for the same RNTI.

In a seventh possible implementation form of the method according to the fifth or sixth possible implementation forms of the method according to the second aspect, RA-RNTIs, P-RNTIs, and SI-RNTIs, are special types of RNTIs (indicating high probability that the decoded candidate CCH is an actual CCH), and wherein the processor is further configured to set the computed MV for the detected current possible RNTI, which is from the special types, higher than an MV for a detected current possible RNTI which is not from the special types.

In an eighth possible implementation form of the method according to the second to the seventh possible implementation forms of the method according to the second aspect or to the second aspect as such, the receiving device is served by at least one serving cell, and the decoded candidate CCH is addressed for another receiving device associated with a non-serving cell.

In a ninth possible implementation form of the method according to the second to the seventh possible implementation forms of the method according to the second aspect or to the second aspect as such, the receiving device is served by at least one serving cell, and the decoded candidate CCH is addressed for another receiving device associated with the serving cell, and wherein the processor is further configured to store the CI in connection with mobility handling for the receiving device.

In a tenth possible implementation form of the method according to any of the preceding possible implementation forms of the method according to the second aspect or to the second aspect as such, the processor is further configured to compute the MV based on one or more information in the group comprising path metric of a decoder of the receiving device, LLR, statistics of the decoder, amount of change of LLRs of the decoder, raw BER, estimate of the decoder, estimated SNR, or SNIR, for the candidate CCH, and effective coding rate for the candidate CCH.

In a eleventh possible implementation form of the method according to any of the preceding possible implementation forms of the method according to the second aspect or to the second aspect as such, the CCH is a PDCCH, the DCH is a PDSCH, and the CI is DCI.

The advantages of the methods according to the second aspect are the same as those for the receiving device according to the first aspect.

According to a third aspect of the disclosure, the above mentioned and other objectives are achieved with a wireless communication system comprising at least one receiving device according to the first aspect.

The present disclosure also relates to a computer program, characterized in code means, which when run by processing means causes said processing means to execute any method according to the present disclosure. Further, the disclosure also relates to a computer program product comprising a computer readable medium and said mentioned computer program, wherein said computer program is included in the computer readable medium, and comprises of one or more from the group of Read-Only Memory (ROM), Programmable ROM (PROM), Erasable PROM (EPROM), Flash memory, Electrically EPROM (EEPROM) and hard disk drive.

Further applications and advantages of the present disclosure will be apparent from the following detailed description.

### BRIEF DESCRIPTION OF THE DRAWINGS

The appended drawings are intended to clarify and explain different embodiments of the present disclosure.

FIG. 1 shows a receiver device according to an embodiment of the present disclosure;

FIG. 2 shows a method according to an embodiment of the present disclosure;

FIG. 3 shows a flowchart of a further method according to an embodiment of the present disclosure;

FIG. 4 illustrates the use of history information in the present solution; and

FIG. 5 shows a wireless communication system according to an embodiment of the present disclosure.

### DETAILED DESCRIPTION

In LTE downlink, cell edge UE performance is limited by interference from neighbouring cells. Not knowing the parameters of the interfering PDSCH signals will degrade the interference mitigation performance at the receiver device. Parameter blind estimation can partly solve the problem, yet not satisfactory.

In embodiments of the present disclosure it is shown how to decode the CCHs of interferers and interpret the information of the associated DCHs signal in the interfering CCH. In this way, the performance of DCH interference mitigation and cancellation can be improved.

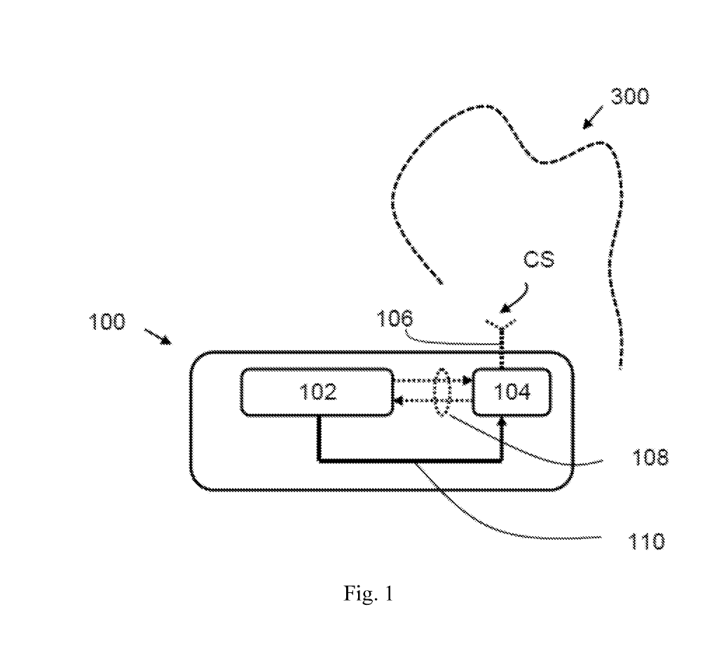

FIG. 1 shows a receiver device 100 (e.g. a UE or a mobile station) according to an embodiment of the present disclosure. The receiver device 100 comprises a processor 102 which is communicably coupled with coupling means 108 to a receiver 104. The coupling means 108 are illustrated as dotted arrows between the processor 102 and the receiver 104 in FIG. 1. The coupling means 108 are according to techniques well known in the art (e.g. such as suitable circuitry, wires and/or traces, etc.). The coupling means 108 may be used for transfer of data and/or signalling between the processor 102 and the receiver 104. The receiver device 100 in this particular embodiment further comprises control means 110 by which the processor 102 operates (or controls) the receiver 104. The control means 110 are illustrated with the arrow from the processor 102 to the receiver 104. The receiver device 100 also comprises antenna means 106 coupled to the receiver 104 for reception (and possibly transmission) in the wireless communication system 300.

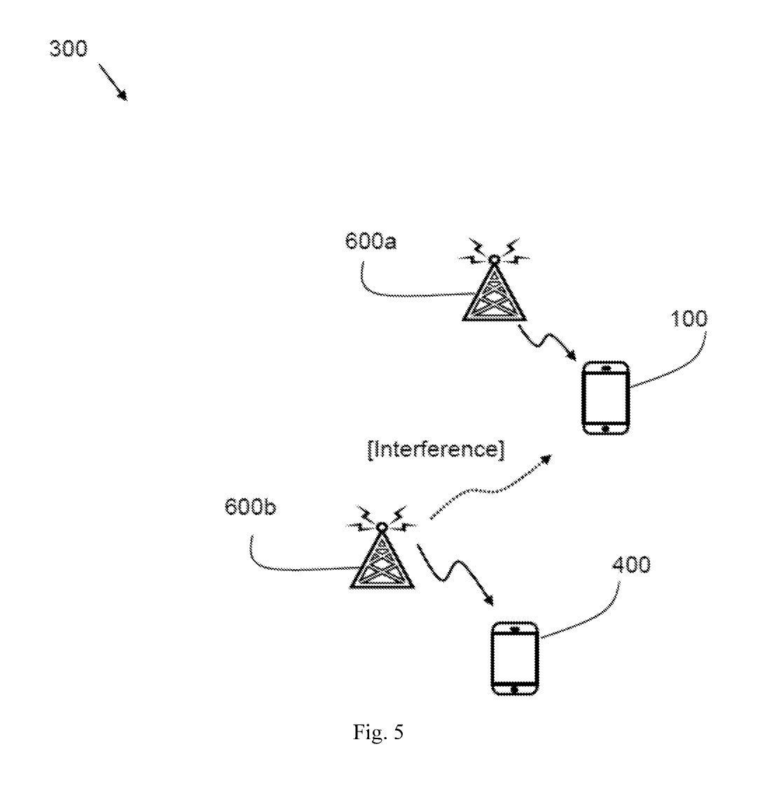

According to the present solution, the receiver 104 is configured to receive a CS in a current time frame of the wireless communication system 300. The processor 102 is configured to determine a set of candidate CCHs, wherein each candidate CCH in the set is addressed for another receiver device (such as a receiver device 400 shown in FIG. 5) and associated with a DCH of the CS. The processor 102 is further configured to determine a decoding order for the candidate CCHs in the set. The processor 102 is further configured to decode at least one candidate CCH in the set according to the previously determined decoding order. The processor 102 is further configured to compute a possible RNTI for the decoded candidate CCH (as example the RNTI can be associated or allocated to a transmitting device sending the CCH and the RNTI is included in the CCH). The processor 102 is further configured to compute an MV for the decoded candidate CCH. The MV provides an indication if the decoded candidate CCH might be an actual CCH or not.

The MV may be a scalar value, such as an LLR value, in a predetermined rang. For example, there may be many LLRs values for the decoded CCH, and the LLR values for the CCH can be compared to one or more threshold values, such that a LLR value larger than the threshold value is considered as an MV. Hence, if there are many LLR values larger than the threshold value for a candidate CCH it can be determined that the candidate CCH is with high probability an actual CCH. Otherwise the candidate CCH is not considered as an actual CCH.

Furthermore, the processor 102 is further configured to determine if the decoded candidate CCH is an actual CCH based on the computed possible RNTI and the MV. The processor 102 is further configured to derive CI from the decoded candidate CCH if the decoded candidate CCH is previously determined as an actual CCH. The processor 102 is finally configured to cancel interference and/or suppress interference in the CS based on the derived CI.

The receiver device 100 may in one embodiment be a user device, such as a UE, mobile station, wireless terminal and/or mobile terminal enabled to communicate wirelessly in the wireless communication system 300, sometimes also referred to as a cellular radio system. The UE may further be referred to as mobile telephones, cellular telephones, computer tablets or laptops with wireless capability. The UEs in the present context may be, for example, portable, pocket-storable, hand-held, computer-comprised, or vehicle-mounted mobile devices, enabled to communicate voice and/or data, via the radio access network, with another entity, such as another receiver or a server. The UE can be a Station (STA), which is any device that contains the Institute of Electrical and Electronics Engineers (IEEE) 802.11-conformant Media Access Control (MAC) and Physical Layer (PHY) interface to the Wireless Medium (WM).

However, the receiver device 100 may in another embodiment be a (radio) network node or a base station, e.g. a Radio Base Station (RBS), which in some networks may be referred to as transmitter, “eNB,” “eNodeB,” “NodeB” or “B node,” depending on the technology and terminology used. The radio network nodes may be of different classes such as e.g. macro eNB, home eNB or pico base station, based on transmission power and thereby also cell size. The radio network node can be a STA, which is any device that contains an IEEE 802.11-conformant MAC and PHY interface to the WM.

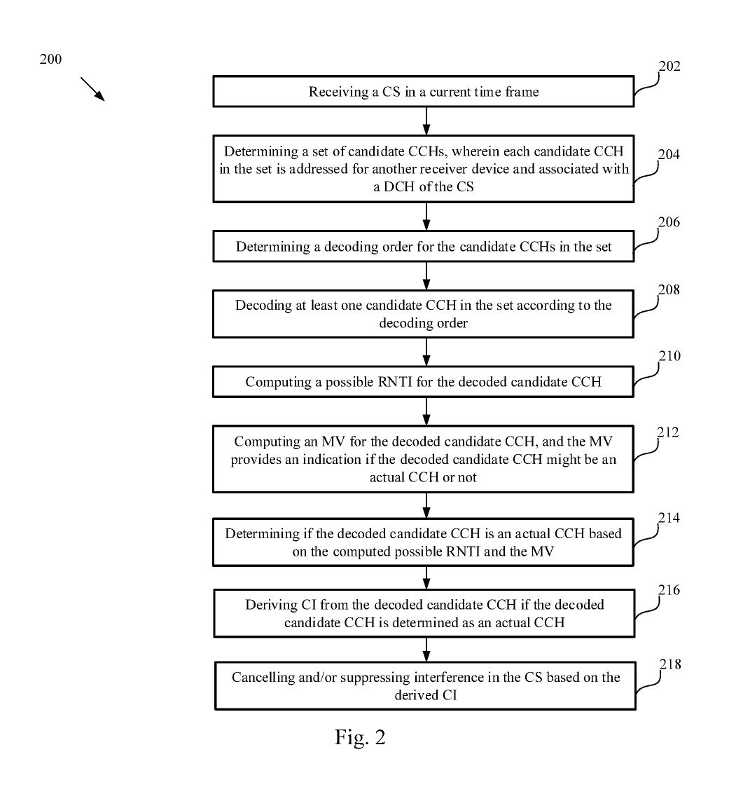

FIG. 2 shows a corresponding method 200 according to an embodiment of the present disclosure. The method 200 may be executed in a receiver device 100, such as the one shown in FIG. 1. The method 200 comprises the following steps.

Step 202: Receiving a CS in a current time frame.

Step 204: Determining a set of candidate CCHs, wherein each candidate CCH in the set is addressed for another receiver device and associated with a DCH of the CS.

Step 206: Determining a decoding order for the candidate CCHs in the set.

Step 208: Decoding at least one candidate CCH in the set according to the decoding order.

Step 210: Computing a possible RNTI for the decoded candidate CCH.

Step 212: Computing an MV for the decoded candidate CCH, and the MV provides an indication if the decoded candidate CCH might be an actual CCH or not.

Step 214: Determining if the decoded candidate CCH is an actual CCH based on the computed possible RNTI and the MV.

Step 216: Deriving CI from the decoded candidate CCH if the decoded candidate CCH is determined as an actual CCH.

Step 218: Cancelling and/or suppressing interference in the CS based on the derived CI.

Embodiments of the present disclosure therefore provide improved knowledge about the parameters or information of the interfering DCH signals. The information about the interfering DCH may include but is not limited to transmission mode, transmission rank, precoding matrix, power level, modulation scheme, resource allocation, etc. Such information of the interfering DCH signals can be used for cancelling and/or mitigating the interfering DCH signals. An example of IC is Network Assisted Interference Cancellation and Suppression (NAICS), and an example of interference mitigation is Minimum Mean Square Error-Interference Rejective Combining (MMSE-IRC).

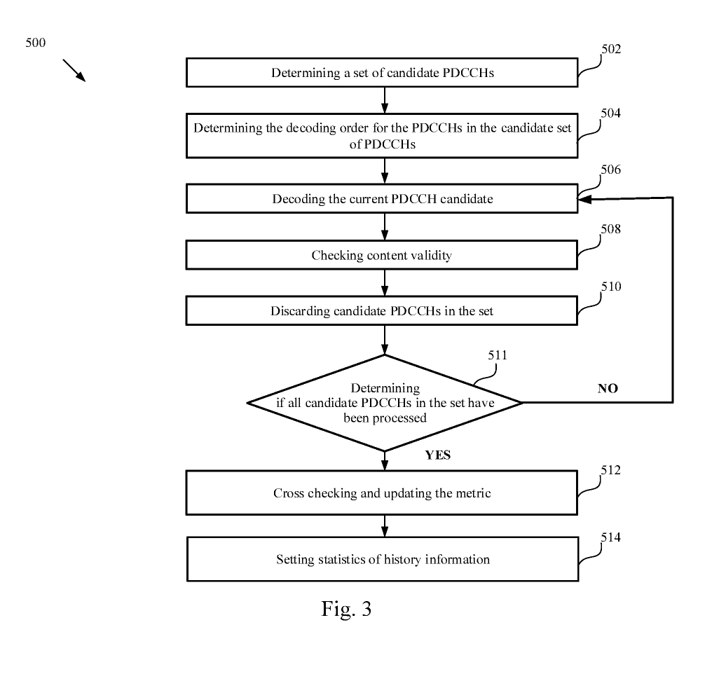

FIG. 3 shows a flow chart of a method 500 according to a further embodiment of the present disclosure. The terminology used in this exemplary embodiment is taken from LTE systems. Therefore, the CCH corresponds to a PDCCH, the DCH corresponds to a PDSCH, and the CI corresponds to DCI according to this terminology. The receiver device in the following examples is a UE. It should however be noted that embodiments of the present disclosure are not limited to such LTE systems and can be applied in other wireless communication system having the system structure suited for the present solution.

In the following, the different steps of the method 500 will be described in detail.

Step 502: Determining a set of candidate PDCCHs received in the CS in a current subframe (e.g. defined by a radio frame structure of an underlying communication system). The PDCCH of the LTE system has a DCI which includes resource assignments for a UE or a group of UEs. There are several different types of DCIs, for example Format 1, 1A, 1B, 1C, 1D, 2, etc., in LTE systems. The PDCCH is transmitted on CCEs, and one PDCCH channel may occupy 1, 2, 4, or 8 CCEs for the reason of robust receiving performance by introducing different amount of redundancy. Therefore, in step 502 the resource element group (REG)/CCE mapping, CCE aggregation level, and LLR for each possible PDCCH bit is determined for the candidate PDCCHs of the candidate set.

Step 504: Determining the decoding order for the PDCCHs in the candidate set of PDCCHs. The main purpose for selecting an order is to make it possible to reduce the complexity of the present solution by reducing the number of candidates. For example, a candidate PDCCH which occupies 8 CCEs is decoded and the decoding result is considered to be very reliable (for example due to the corresponding RNTI is a known active RNTI in the interfering cell), then for complexity reason the other candidate PDCCHs in the set that occupy any of these 8 CCEs may be discarded from the set. In this way, many candidate PDCCCHs may be discarded from the set and thus the total complexity is significantly reduced. Moreover, in order to achieve very robust PDCCH receiving performance, there is a high probability that the eNBs will transmit PDCCH at the 4 or 8 CCE aggregation levels. Therefore, by decoding CCHs with higher aggregation levels first (e.g. 4 and 8 CCEs aggregation levels) and decoding CCHs with lower aggregations levels afterwards in general the total complexity will be reduced significantly. Another criterion for determining the decoding order is the energy levels of the candidate PDCCH for reducing the complexity. Therefore, according to an embodiment of the disclosure, the decoding order is based on the energy levels of the candidate CCHs in the set, wherein candidate CCHs with higher energy level get a higher decoding priority (are earlier decoded) than candidate CCHs with lower energy level. According to a further embodiment the decoding order is instead or additionally based on the aggregation level of the candidate CCHs, i.e. how many CCEs the candidate CCHs occupy, wherein candidate CCHs with higher aggregation level get a higher decoding priority (are earlier decoded) than candidate CCHs with lower aggregation level.

Step 506: Decoding the current PDCCH candidate. Based on the decoding results of a candidate PDCCH one RNTI value can be directly computed by assuming that the candidate PDCCH is actually a valid PDCCH and when the information bits and cyclic redundancy check (CRC) bits of the candidate PDCCH are detected correctly. Moreover, an MV for the candidate PDCCH is computed and used for determining if the candidate PDCCH is an actual PDCCH. The determination can for example be based on a comparison of the MV with a threshold value. If the MV is larger than the threshold value then the candidate PDCCH may be determined as an actual PDCCH otherwise, the candidate PDCCH would be discarded. The RNTI values for different RNTI types are allocated and given in specifications, such as the 3GPP 36.321 specification.

According to an embodiment of the present disclosure, the MV can be a function whose input can be based on one or more of the following information in the group including:

Path metrics of the decoder (not shown in FIG. 1) of the receiver device 100, such as a Viterbi decoder;

LLR statistics of the soft output of the decoder, which can be any kind of statistical information computed from the LLR, one typical example is the mean mutual information;

Ratio of the amount of bits whose LLR signs (+ or −) changed during the decoding;

Estimated SNR and/or SINR of the candidate PDCCH;

Effective coding rate considering the CCE aggregation level for the candidate PDCCH;

Raw BER estimate of the LLR input to the decoder. By comparing the LLR input and LLR output of the decoder and check how many bits have their sign changed (+ or −) after the decoding process, the raw BER estimate can be computed, since error correcting codes are usually supposed to operate well only at a certain BER range.

Step 508: Checking content validity. It is assumed that the decoded result of the step 506 is a PDCCH of a certain DCI format, and the information bits of the DCI format are fetched and of the corresponding detected RNTI. Thereafter, the content of the PDCCH DCI information can be validated to check whether the PDCCH DCI information comply with standard specifications, such as 3GPP specifications. For example, for a specific subframe number and a specific Cell-RNTI (C-RNTI), there is a constraint about the CCE range which must be followed. In other words, only a subset of CCEs and their aggregations can contain PDCCH for that C-RNTI at each subframe. If this is not satisfied, the decoded candidate PDCCH does not exist or contains error in the decoded bits. In the first case the computed RNTI is a false alarm meaning that the computed RNTI does not exist but was wrongly considered to exist, and in the second case the computed RNTI is incorrect. In either of these cases, the decoded candidate PDCCH is discarded, or a very small MV may be assigned to this decoded candidate PDCCH.

Step 510: Discarding candidate PDCCHs in the set. Based on the above validity check in step 508, if there is high confidence that a certain candidate PDCCH is correctly decoded, some of the candidate PDCCHs from the candidate set to be decoded can be removed (discarded). For example, if a PDCCH containing 8 CCEs is decoded and it is highly confident that the PDCCH is an actual PDCCH all those other possible PDCCH candidates that occupy any of these 8 CCEs may be removed or discarded from the candidate set. In this way a large number of PDCCH candidates can be removed and the total complexity can be significantly reduced.

In Step 511: Determining if all candidate PDCCHs in the set have been processed. If the answer is NO in step 511, the algorithm returns to step 506 and starts decoding the next PDDCH candidate according to the decoding order. If the answer is YES in step 511, the algorithm continues to step 512 in FIG. 3.

Step 512: Cross checking and updating the metric. The obtained different kinds of information are combined and cross checking is performed to determine the final list of PDCCH candidates among the PDCCH candidates from the set. Moreover, the MV may also be adjusted in this step. The information that may be used in this step may include, but is not limited to the following.

Statistical information of the detected RNTIs and the MVs;

Blind estimation information of the interfering PDSCH signals. From the information about the PDSCH, the information of PDCCH associated with this PDSCH can be deduced. Hence, the algorithm can cross-verify whether the detected RNTI is correct or not; and

Cross dependence of the content of survival candidate PDCCHs. For example, if two survival candidate PDCCHs claim or occupy the same Physical Resource Block (PRB) resources, then something may be wrong if Non-Orthogonal Multiple-Access (NOMA)/Semi-Orthogonal Multiple-Access (SOMA) is not being used.

In step 514: Setting statistics of history information. The RNTI and MV information in the current subframe will be combined with the historical statistics such that the MV information will be filtered. Moreover, if a RNTI has not been detected for quite some time, and the MV associated with this particular RNTI is getting small, then this RNTI may be removed from the list of detected RNTIs in the current subframe.

Moreover, some RNTIs may be treated as so called “special” RNTIs. The special RNTIs are just a very small portion of all possible RNTIs, for example RA-RNTI (with value 0000˜0009), P-RNTI (with value FFFE), SI-RNTI (with value FFFF). If a reported possible RNTI is a special RNTI, it should have a high MV, since a randomly reported error RNTI should fall in these special RNTI range is very small, of around 10̂(−4) in probability. In other words, special RNTIs can be regarded as “almost always active RNTIs” in the interfering cells. Therefore, according to an embodiment of the present disclosure, RA-RNTIs, P-RNTIs, and SI-RNTIs, are special types of RNTIs indicating a very high probability that the decoded candidate CCH comprising such special RNTI is an actual CCH. Hence, the processor 102 of the receiver device 100 shown in FIG. 1 is configured to set the MV for the detected current possible RNTI, which is from the special types, higher than an MV for a detected current possible RNTI which is not from the special types.

In the wireless communication system 300 shown in FIG. 1, when a receiver device 100 needs to access the internet, the receiver device 100 will usually send or receive multiple frames within a certain time period. For example, under the use case of internet surfing, the receiver device 100 usually receives many frames in a few seconds, and will thereafter not receive anything for many seconds or even minutes. Under the use case of voice conversation, such as SKYPE or streaming, the receiver device 100 will usually receive frames almost periodically within short time intervals. In other words, it is more common that the receiver device 100 will be active within a certain period of time and receive multiple frames, and then it will be non-active and not receive anything for quite some time, or sometime it will handover to other cells and disappear from nearby.

Based on the above described behavior of burst communication, if a certain RNTI is detected multiple times as the possible RNTI for candidate interfering PDCCHs during a short time period, it is very probable that the possible RNTI is a real active RNTI in the interfering cell. One reason is that since for an example in LTE the RNTI contains 16 bits, the probability that a single RNTI is a false alarm reported for multiple times within a short period is extremely small. Therefore, the possibility that the detected RNTI is a false RNTI is very low, about 1/2̂16.

Further, the possibility that the same RNTI occurs many times during a short time period and is a false alarm RNTI is extremely low. Because of the above reasons of burst communication behavior of the receiver device 100, the following general rules may be applied according to further embodiments of the present disclosure.

When a RNTI is detected in the current subframe and if the candidate PDCCH has passed the validity check at step 510 in FIG. 3, then if this RNTI has been detected recently in time, the MV for the candidate PDCCH associated with this RNTI should be adjusted higher accordingly.

If a RNTI is detected and has passed the validity check at step 510 in FIG. 3 in previous subframes, while not having been detected in the current subframe, and further if the point in time when the RNTI was last detected is within a certain time period, then it is highly probable that the RNTI is still active in the neighboring cell. Hence, we do not filter out (or fade out) the MV statistics for the RNTI.

If a RNTI is detected and has passed the validity check at step 510 in FIG. 3 in previous subframes, while not having been detected in the current subframe, and further if the point in time when the RNTI was last detected exceeds a time period, then it is highly probable that the RNTI is not active (or may even be handed off from the interfering cell). Hence, the MV for the RNTI should be filtered out (or faded out).

The RNTI may be removed from the list of detected RNTIs, for example when the point in time when the RNTI was last detected exceeds a certain time threshold, or when the MV for the RNTI fades out and becomes smaller than a threshold value.

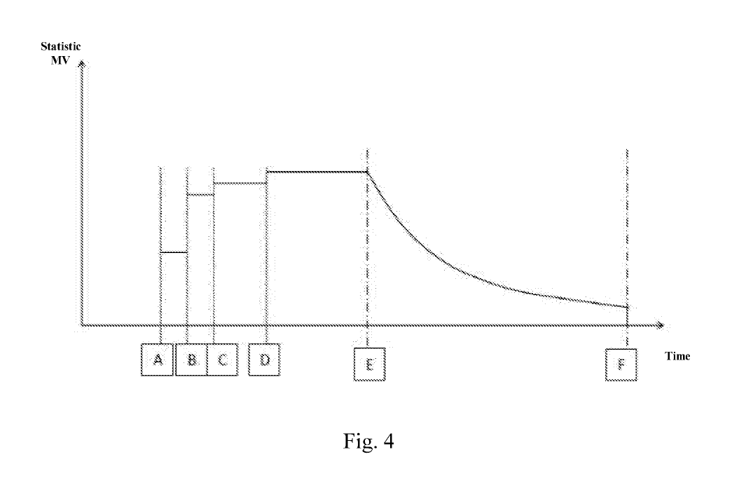

FIG. 4 illustrates and describes the present statistical embodiment more in detail. Especially, FIG. 4 illustrates how a certain RNTI is first detected, thereafter faded out and finally removed from the list of detected RNTIs. In FIG. 4 the x-axis shows time and the Y-axis the statistic MV. With reference to FIG. 4:

At time point A, an RNTI is detected for the first time and the statistic MV is set low.

At time point B, the same RNTI occurs again and the statistic MV is increased since the RNTI has been detected again.

At time point C, the same RNTI occurs once again which means that we have more confidence that the RNTI is a real RNTI, and therefore the statistic MV is increased even more.

At time point D, the statistic MV is held constant for a time period between D and F since the RNTI has not been detected during the time period from C to D.

Between time point E and time point F, the statistic MV is filtered and faded out since there is no more appearance of the RNTI.

At time point F, the RNTI is removed from the list of detected RNTIs since the statistic MV is below a threshold value.

In previous sections, it was described how to detect active RNTIs in the interfering cells and how to use statistical information of the MVs to improve the detection performance and/or reduce total complexity of the present solution. It should also be noted that the described methods can also be used in detecting active RNTIs of other UEs in the serving cell. It is easier to detect the UEs in the serving cell since the UE knows its own RNTI. Using resource conflicting information and conflicting rules together with the knowledge of the UE's own RNTI, it is easier to detect RNTIs of other UEs in the serving cell. When a UE is moving in a cellular network the UE will be handed over to other cells in the cellular network. The serving cell will very often become a strong interfering cell in typical moving scenario after handover. Thus, if the active RNTIs of the serving cell are detected and stored very good knowledge of the active RNTIs will immediately be available after handover. This will help to achieve a good interfering PDCCH detection performance after the handover.

However, there are critical timing requirements for a UE to decode the serving cell's PDSCH channel and report success/failure back to the eNB. Because of this, the UE also need to decode the serving cell's PDCCH channel in time such that the UE can use the DCI information in PDCCH to decode the PDSCH when necessary. As a consequence, when we want to suppress or cancel the interfering PDSCH channels from neighbouring cells the PDCCHs of the interfering cell also should decoded. In general there is no need to decode the PDSCH channels for the other UEs in the serving cell as the PDSCH channels for the other UEs in the serving cell do not interfere with the PDSCH channel for the UE. Hence, there is generally no need to decode the PDCCHs for the other UEs in the serving cell. In this case, if we want to decode the PDCCHs for the other UEs in the serving cell to obtain the active RNTI information, the detection can be performed in the background at a slower speed such that the hardware for decoding the interfering cells PDCCH can be reused, or else a low speed low power consuming hardware block can be used for this purpose.

Another alternative is to decode interfering PDCCH channels from multiple interfering cells. The reason for this is that when performing, e.g. NAICS, we may wish to cancel interfering PDSCH signals from more than one interferer. PDCCHs of interfering cells need to be decoded quickly since the timing requirement is tight. Interference for cells which the receiver device 100 may not be able to cancel due to lack of hardware resources may still be able to decode their PDCCHs in the background and therefore the receiver device 100 may obtain knowledge of the RNTIs gradually.

FIG. 5 illustrates a cellular wireless communication system 300 according to an embodiment of the present disclosure. A first network node 600a, such as a base station, transmits downlink signals to a receiver device 100, such as a user device or UE. The receiver device 100 is therefore served by the first network node 600a. Another receiver device 400 is served by a second network node 600b which is adjacent to the first network node 600a. The transmission from the second network node 600b to receiver device 400 will interfere (illustrated with the dotted arrow) with the transmissions from the first network node 600a to the receiver device 100. The receiver device 100 is configured to apply the present solution described above for IC and/or suppression.

Furthermore, any method according to the present disclosure may be implemented in a computer program, having code means, which when run by processing means causes the processing means to execute the steps of the method. The computer program is included in a computer readable medium of a computer program product. The computer readable medium may be comprised of essentially any memory, such as a ROM, a PROM, an EPROM, a Flash memory, an EEPROM, or a hard disk drive.

Moreover, it is realized by the skilled person that the present receiver device 100 comprises the necessary communication capabilities in the form of e.g., functions, means, units, elements, etc., for performing the present solution. Examples of other such means, units, elements and functions are processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, digital signal processors (DSPs), mass storage devices (MSDs), trellis-coded modulation (TCM) encoder, TCM decoder, power supply units, power feeders, communication interfaces, communication protocols, etc. which are suitably arranged together for performing the present solution.

Especially, the processors of the present device may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like. Finally, it should be understood that the present disclosure is not limited to the embodiments described above, but also relates to and incorporates all embodiments within the scope of the appended independent claims.

What is claimed:

1. A receiver device for a wireless communication system, comprising:
a receiver configured to receive a communication signal (CS) in a current time frame; and
a processor coupled to the receiver and configured to:
determine a set of candidate Control Channels (CCHs), wherein each candidate CCH in the set is addressed for another receiver device and associated with a Data Channel (DCH) of the CS;
determine a decoding order for the candidate CCHs in the set;
decode at least one candidate CCH in the set according to the decoding order;
compute a possible Radio Network Temporary Identifier (RNTI) for the decoded at least one candidate CCH;
compute a metric value (MV) for the decoded at least one candidate CCH, wherein the MV provides an indication when the decoded at least one candidate CCH might be an actual CCH;
determine whether the decoded at least one candidate CCH is the actual CCH based on the computed possible RNTI and the MV;
derive control information (CI) from the decoded at least one candidate CCH when the decoded candidate CCH is determined as the actual CCH; and
cancel or suppress interference in the CS based on the derived CI.

2. The receiver device according to claim 1, wherein the processor is further configured to determine the decoding order based on energy levels of the candidate CCHs in the set.

3. The receiver device according to claim 1, wherein the processor is further configured to:
check validity of the derived CI; and
discard the decoded at least one candidate CCH from the set when the derived CI is invalid.

4. The receiver device according to claim 3, wherein the processor is further configured to discard other candidate CCHs from the set when the other candidate CCHs have been transmitted in the same Control Channel Elements (CCEs) as the decoded at least one candidate CCH and when the derived CI is valid.

5. The receiver device according to claim 3, wherein the processor is further configured to check the validity of the derived CI based on the computed possible RNTI, a subframe number for the decoded at least one candidate CCH, and Control Channel Element (CCE) constraints for the decoded at least one candidate CCH.

6. The receiver device according to claim 1, wherein the processor is further configured to:
detect at least one current possible RNTI for the decoded candidate CCH in the current time frame;
compute the MV for the detected at least one current possible RNTI;
compute statistics for MVs associated with previously detected possible RNTIs for the decoded at least one candidate CCH; and
determine whether the decoded at least one candidate CCH is the actual CCH further based on the computed statistics and the computed MV for the detected at least one current possible RNTI.

7. The receiver device according to claim 6, wherein the computed MV for the detected at least one current possible RNTI and the computed statistics are computed based one or more parameters in a group comprising:
a type of RNTI;
a point in time of detection of the RNTI; and
a number of detections for the same RNTI.

8. The receiver device according to claim 6, wherein Random Access RNTIs (RA-RNTIs), Paging RNTIs (P-RNTIs), and System Information RNTIs (SI-RNTIs), are special types of RNTIs indicating high probability that the decoded at least one candidate CCH is the actual CCH, and wherein the processor is further configured to set the computed MV for the detected at least one current possible RNTI, which is from the special types, higher than the MV for a detected current possible RNTI which is not from the special types.

9. The receiver device according to claim 1, wherein the receiver device is served by at least one serving cell, and wherein the decoded at least one candidate CCH is addressed for the other receiver device associated with a non-serving cell.

10. The receiver device according to claim 1, wherein the receiver device is served by at least one serving cell, wherein the decoded at least one candidate CCH is addressed for the other receiver device associated with the at least one serving cell, and wherein the processor is further configured to store the CI in connection with mobility handling for the receiver device.

11. The receiver device according to claim 1, wherein the processor is further configured to compute the MV based on one or more information in a group comprising:
path metric of a decoder of the receiver device;
Log Likelihood Ratio (LLR) statistics of the decoder;
amount of change of LLRs of the decoder;
raw Bit Error Rate (BER) estimate of the decoder;
estimated Signal to Noise Ratio (SNR) for the at least one candidate CCH; and
effective coding rate for the at least one candidate CCH.

12. The receiver device according to claim 1, wherein the processor is further configured to compute the MV based on one or more information in a group comprising:
path metric of a decoder of the receiver device;
Log Likelihood Ratio (LLR) statistics of the decoder;
amount of change of LLRs of the decoder;
raw Bit Error Rate (BER) estimate of the decoder;
estimated Signal to Noise and Interference Ratio (SNIR) for the at least one candidate CCH; and
effective coding rate for the at least one candidate CCH.

13. The receiver device according to claim 1, wherein the processor is further configured to determine the decoding order based on control channel element (CCE) aggregation levels of the candidate CCHs in the set.

14. A method, comprising:
receiving a communication signal (CS) in a current time frame;
determining a set of candidate Control Channels (CCHs), wherein each candidate CCH in the set is addressed for a receiving device and associated with a Data Channel (DCH) of the CS;
determining a decoding order for the candidate CCHs in the set;
decoding at least one candidate CCH in the set according to the decoding order;
computing a possible Radio Network Temporary Identifier (RNTI) for the decoded at least one candidate CCH;
computing a metric value (MV) for the decoded at least one candidate CCH, wherein the MV provides an indication when the decoded at least one candidate CCH might be an actual CCH;
determining whether the decoded at least one candidate CCH is the actual CCH based on the computed possible RNTI and the MV;
deriving control information (CI) from the decoded at least one candidate CCH when the decoded at least one candidate CCH is determined as the actual CCH; and
cancelling interference in the CS based on the derived CI.

15. A method, comprising:
receiving a communication signal (CS) in a current time frame;
determining a set of candidate Control Channels (CCHs), wherein each candidate CCH in the set is addressed for a receiving device and associated with a Data Channel (DCH) of the CS;
determining a decoding order for the candidate CCHs in the set;
decoding at least one candidate CCH in the set according to the decoding order;
computing a possible Radio Network Temporary Identifier (RNTI) for the decoded at least one candidate CCH;
computing a metric value (MV) for the decoded at least one candidate CCH, wherein the MV provides an indication when the decoded at least one candidate CCH might be an actual CCH;
determining whether the decoded at least one candidate CCH is the actual CCH based on the computed possible RNTI and the MV;
deriving control information (CI) from the decoded at least one candidate CCH when the decoded at least one candidate CCH is determined as the actual CCH; and
suppressing interference in the CS based on the derived CI.
